(19) United States
(12) Patent Application Publication
(10) Pub. No.: US 2002/0149124 A1
(43) Pub. Date: Oct. 17, 2002

(54) Automatic bubble generator

(76) Inventor: Hsu-Wen Liao, Ping-Chen City (TW)

Correspondence Address: Alan Kamrath, RIDER BENNETT EGAN & ARUNDEL, LLP, Suite 2000, 333 South Seventh Street, Minneapolis, MN, 55402, US

(21) Appl. No.: 09/833,227

(22) Filed: Apr. 11, 2001

(51) Int. Cl. B01F 3/04

(52) U.S. Cl. 261/123

(57) ABSTRACT

A automatic bubble generator has a bubble solution reservoir to hold bubble solution and has an outlet nozzle and an air supply tube with a primary tube extending into the bubble solution reservoir and immersed in the solution for providing air to generate bubbles and having an auxiliary tube extending to and below the outlet nozzle of the bubble solution reservoir.

### BACKGROUND OF THE INVENTION

1. Field of the Invention

The present invention relates to a bubble generator, and more particularly to an automatic bubble generator having a bubble solution reservoir with an outlet nozzle and a supply air tube that extends into the bubble solution reservoir and to the outside of tile outlet nozzle. When air flows into the solution through the supply air tube and to the outlet nozzle, bubbles generated from the flow of air inside the bubble solution reservoir will be driven out through the nozzle by the flow of air below the outlet nozzle.

2. Description of Related Art

A bubble generator is a favorite toy of children. From the floating bubbles, children are able to observe a variety of colors when the sunlight reflects through, and that is why children love to play with the bubble generator Automatic bubble generators available in the market are too complex and complicated for children to handle if there is a malfunction. Therefore, when the bubble generator is out of order and because there is nothing children can do to solve the problem, children lose interest in playing with it any longer.

To overcome the shortcomings, the present invention intends to provide an improved bubble generator to mitigate and obviate the aforementioned problems.

### SUMMARY OF THE INVENTION

The primary objective of the invention is to provide an improved automatic bubble generator with a simple structure and easy to operate.

To achieve the foregoing objective, the bubble generator in accordance with the present invention has a bubble solution reservoir and a supply air tube extending to an outlet of the bubble solution reservoir and into the the bubble solution reservoir. When air is blown into the tube, air flows to the inside of the bubble solution reservoir and the outlet of the bubble solution reservoir. Bubbles will be generated by the air flowing inside the bubble solution reservoir. After the bubbles are generated and move to the top of the bubble solution reservoir, the flowing air across the outlet draws the bubbles out of the bubble solution reservoir.

Another objective of the invention is to provide a blower at the outlet to facilitate dispersing the bubbles out of the bubble solution reservoir.

Still another objective of the invention is to provide a compressor to provide compressed air to be blown into the bubble solution reservoir.

A further objective of the invention is to provide a transmission device driven by electricity to drive the compressor and he blower.

Other objects, advantages and novel features of the invention will become more apparent from the following detailed description when taken in conjunction with the accompanying drawings.

### BRIEF DESCRIPTION OF THE DRAWINGS

FIG. 1 is a side plan view of in partial section a preferred embodiment of the automatic bubble generator in accordance with the present invention;

FIG. 2 is a side plan view in partial section of a second embodiment of the automatic bubble generator in accordance with the present invention; and

FIG. 3 is an operational top plan view of the automatic bubble generator in FIG. 2.

### DETAILED DESCPRIPTION OF PREFERRED EMBODIMENT

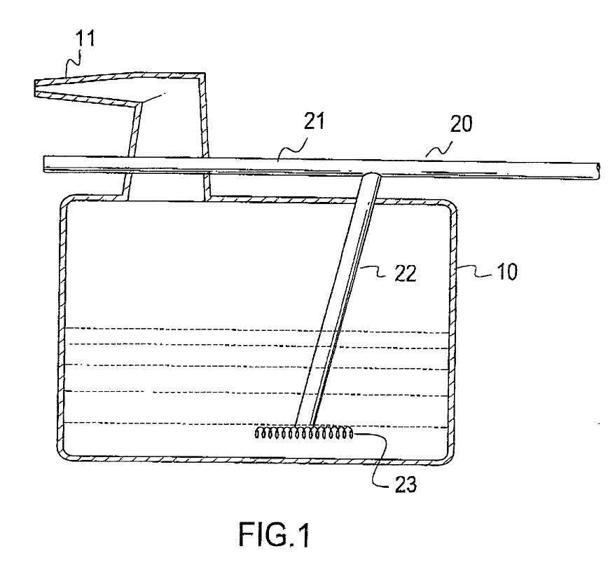

With reference to FIG. 1, the automatic bubble generator in accordance with the present invention has a bubble solution reservoir (10) and an air supply tube (20) having a primary tube (21) extending; to an outlet nozzle (11) of the bubble solution reservoir (10) and an auxiliary tube (22) extending into the bubble solution reservoir (10). The distal end of the primary tube (21) extending to the outlet (11) of the bubble solution reservoir (10) is below the outlet (11) and the distal end of the auxiliary tube (22) has a bubble facilitator (23), an annular twisted wire for example.

When the air flows in the tube (20) and into the bubble solution reservoir (10), bubbles will be generated due to the solution inside the bubble solution reservoir (10)Further, when air flows through the outlet (11), the pressure inside the bubble solution reservoir (10) is larger than the pressure around the outlet nozzle (11), such that the bubbles generated inside the bubble solution reservoir (10) will be forced by the pressure inside the bubble solution reservoir (10) to the outlet nozzle (11) and eventually out of the bubble solution reservoir (10).

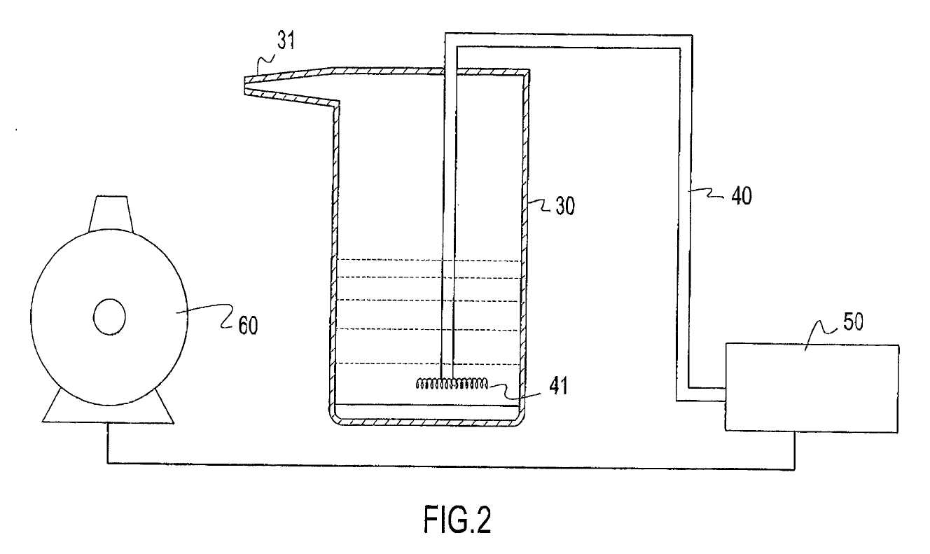

With reference to FIG. 2, a second preferred embodiment of the automatic bubble generator in accordance with the present invention has a bubble solution reservoir (30), an air supply tube (40), a compressor (50) and an air blower (60).

The bubble solution reservoir (30) has an outlet nozzle (31) defined in a top portion of the bubble solution reservoir (30). A first distal end of the tube (40) rests in the bubble solution reservoir (30) and is surrounded by solution inside the bubble solution reservoir (30). A second distal end of the tube (40) connects with the compressor (50) so that compressed air is continuously blown into the bubble solution reservoir (30) to generate bubbles. To further speed up the generation of bubbles inside the bubble solution reservoir (30), a bubble facilitator (41) such as an annular twisted wire is provided at the first distal end of the tube (40). The air blower (60) provided below the outlet nozzle (31) of the bubble solution reservoir (30) is able to force the bubbles away from the outlet (31) to prevent bubbles from clogging at the outlet (31).

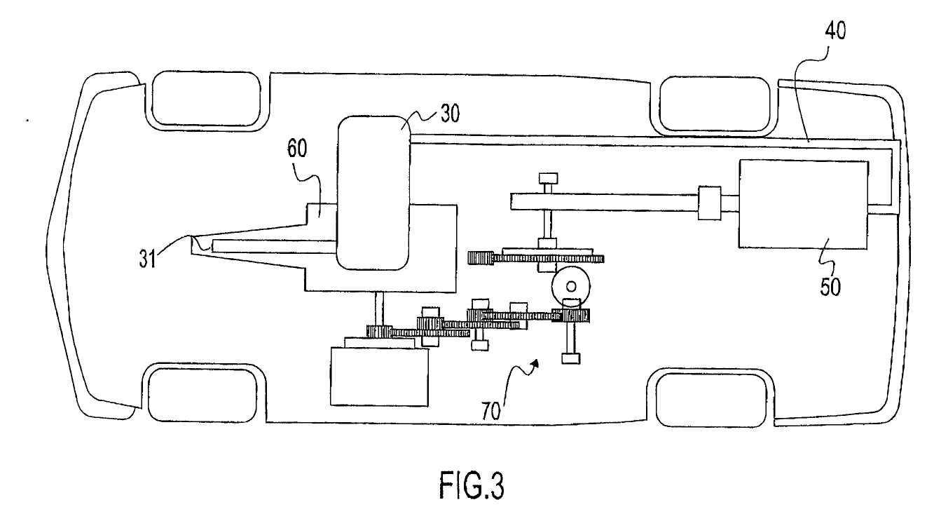

With reference to FIG. 3 when the second preferred embodiment of the automatic bubble generator is applied, a transmission device (70) from a toy car can be respectively connected to the compressor (50) and the air blower (60) so as to drive the compressor (50) and the air blower (60) individually to provide air to the bubble solution reservoir (30) to generate bubbles and air to the outlet nozzle (31) of the bubble solution reservoir (30) to force the generated bubbles out of the bubble solution reservoir (30).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims ate expressed.

What is claimed is:

1. An automatic bubble generator comprising:
a bubble solution reservoir for bubble solution and having an outlet nozzle; and
an air supply tube with a primary tube extending into the bubble solution reservoir and immersed in the bubble solution for providing air to generate bubbles and having an auxiliary tube extending to and below the outlet nozzle of the bubble solution reservoir.

2. The automatic bubble generator as claimed in claim 1, wherein a bubble facilitator is mounted at a distal end of the primary tube.

3. The automatic bubble generator as claimed in claim 1 further having a compressor connected to the air supply tube for providing air to the bubble solution reservoir.

4. The automatic bubble generator as claimed in claim 3 further comprising an air blower provided below the outlet nozzle to force generated bubbles out of the bubble solution reservoir.

5. The automatic bubble generator as claimed in claim 2 further comprising a compressor connected to the tube for providing air to the bubble solution reservoir.

6. The automatic bubble generator as claimed in claim 5 further comprising an air blower provided below the outlet nozzle to force generated bubbles out of the bubble solution reservoir.

7. The automatic bubble generator as claimed in claim 3 further comprising a transmission device connected to the compressor to drive the compressor.

8. The automatic bubble generator as claimed in claim 4 further comprising a transmission device connected to the air blower to drive the air blower.

9. The automatic bubble generator as claimed in claim 5 further comprising a transmission device connected to the compressor so as to drive the compressor.

10. The automatic bubble generator as claimed in claim 6 further comprising a transmission device connected to the air blower to drive the air blower.
